(19) United States
(12) Patent Application Publication
(10) Pub. No.: US 2026/0194881 A1
(43) Pub. Date: Jul. 9, 2026

(54) METHOD AND SYSTEM FOR DETERMINING APPROVALS FOR CONTROL UNIT FUNCTIONS IN A CONTROL UNIT OF A TECHNICAL DEVICE

(71) Applicant: Robert Bosch GmbH, Stuttgart (DE)

(72) Inventors: Alexander Hinz, Sachsenheim (DE); Eckart Schlottmann, Affalterbach (DE); Hans Hillner, Ludwigsburg (DE); Kai Perrot, Bechtolsheim (DE); Reinhard Keil, Schwieberdingen (DE); Thomas Illig, Kirchheim Am Neckar (DE)

(21) Appl. No.: 19/129,455

(22) PCT Filed: Nov. 9, 2023
(86) PCT No.: PCT/EP2023/081255

§ 371 Date: May 13, 2025

(30) Foreign Application Priority Data
Nov. 18, 2022 (DE) 10 2022 212 287.9

(51) Int. Cl. G05B 19/406

(52) U.S. Cl. CPC G05B 19/406; G05B 2219/33227

(57) ABSTRACT

A computer-implemented method for operating an approval manager for approving control unit functions of different safety levels in a control unit of a technical system. The method includes: carrying out diagnostic functions in the control unit, wherein a safety level is assigned to each of the diagnostic functions; depending on the detection of a fault event or a functionality by the relevant diagnostic function, adjusting an associated status variable in a status variable memory area assigned to the safety level of the diagnostic function; carrying out a control unit function, which is assigned to a particular safety level, depending on one or more associated status variables, wherein only status variables which are stored in status variable memory areas assigned to the safety level of the control unit function or higher safety levels are taken into account.

### FIELD

The present invention generally relates to control units in which control unit functions are implemented that are assigned to different safety levels. The method also relates to the execution of the control unit functions in the control unit depending on approvals that depend on diagnostic results of functional diagnostics for the individual control unit functions.

### BACKGROUND INFORMATION

Control units are currently used to control a wide variety of technical devices. Such control units, which are usually implemented using a microcontroller, are usually operated with functional software with generally a plurality of functional modules, each of which can contain a plurality of control unit functions. Such control unit functions can include, for example, functions of the operating system and memory management, central functions of on-board diagnostics, functions of fault memory management and work functions for the implementation of control unit tasks. The control unit functions are generally interrelated in order to fulfill a control and regulation task.

The control unit is used to control a technical system. Depending on the area of application of the technical system, malfunctions of individual control unit functions can cause more or less critical behavior of the technical system, which can lead to a reduction in the usability of the technical system or make it unusable, or damage or destroy parts of the technical system.

It is therefore provided to monitor the control unit functions using one or more diagnostic functions. A fault detected by a diagnostic function results in the setting of a corresponding fault status (status variable), which is retrieved for the approval of the execution of the corresponding control unit function.

With the aid of a so-called approval manager (function inhibition manager (FIM)), the approval and blocking of individual control unit functions can be coordinated depending on a detected fault event. Such a function inhibition manager operates with a blocking matrix, which takes into account a control unit function identified with the aid of a function identifier depending on a fault event identifier of a fault detected by an assigned diagnostic function and contains a status variable that is assigned to the control unit function and with which a detected fault can be displayed.

An industry standard for such an approval manager is described, for example, in AUTOSAR “Specification of Function Inhibition Manager,” AUTOSAR Document Identification No. 82, Release R21-11.

### SUMMARY

The present invention provides, among other things, a method for operating an approval manager for approving control unit functions with different safety levels and a corresponding apparatus.

Example embodiments of the present invention are disclosed herein.

According to a first aspect of the present invention, a method is provided for operating an approval manager for approving control unit functions of different safety levels in a control unit of a technical system. According to an example embodiment of the present invention, the method includes the following steps:
carrying out diagnostic functions in the control unit, wherein a safety level is assigned to the diagnostic function;
depending on the detection of a fault event or a functionality by the relevant diagnostic function, adjusting an associated status variable in a status variable memory area assigned to the safety level of the diagnostic function;
carrying out a control unit function, which is assigned to a particular safety level, depending on one or more associated status variables, wherein only status variables which are stored in status variable memory areas assigned to the safety level of the control unit function or higher safety levels are taken into account.

According to an example embodiment of the present invention, in the approval manager (function inhibition manager), a link is created between a fault event identifier, to which a diagnostic function is assigned, and a function identifier. A fault event, identified by the fault event identifier, leads to the incrementation or setting of a status variable that is assigned to function identifier and thus to a specific control unit function. In this way, when a fault is detected with the aid of a diagnostic function, the approvals of one or more control unit functions can be influenced via the corresponding function identifier.

Therefore, if a fault detection is indicated by a specific event identifier, the status variables of the function identifiers assigned by the blocking matrix are adjusted accordingly.

However, in the above implementation, all diagnostic functions and control unit functions must have the same integrity, i.e., be assigned to the same safety level or, for the automotive sector, the same ASIL level (ISO 26262). The same integrity means that all diagnostic functions relevant to a control unit function can access the same status variable memory areas and exchange information directly.

However, the safety level specifies that diagnostic functions of a particular safety level cannot have write access to status variable memory areas of a higher safety level. In contrast, control unit functions have read access to memory areas of all safety levels. It must be ensured that diagnostic functions with a lower safety level that have led to a fault detection cannot block the execution of a control unit function with a higher safety level.

The above-describes method of the present invention provides for the approval of control unit functions to be carried out depending on the result of diagnostic functions, taking into account their safety levels and an approval manager. For this purpose, the approval manager has (in advance) a status variable memory area for each safety level in order to store status variables of the control unit functions. The status variables are each assigned to a specific control unit function, represented by a function identifier, and are adapted for diagnostic messages, provided that a corresponding assignment of diagnostic function and function identifier is stored. The status variables can be designed as fault counters. In the latter case, the status variables can be incremented when a fault of the associated fault function occurs and, if certain criteria are met, decremented accordingly when the absence of a fault is established.

According to an example embodiment of the present invention, each diagnostic function is assigned a safety level. Accordingly, each diagnostic function adjusts a status variable of the function identifier for its respective safety level. An adjustment can be made, for example, if a fault event has been detected or if a fault-free function has been established after a fault event has been detected. If a fault is detected, the status variable is incremented accordingly and, if proper function is detected by the same diagnostic function, the status variable is decremented accordingly if its value is greater than zero.

According to an example embodiment of the present invention, when a control unit function is carried out, its approval is always checked according to its assigned safety level. The approval is carried out using one or more status variables assigned by an assignment matrix. If one or more status variables of the safety level of the control unit function to be executed indicate a fault detection, the execution of the control unit function is blocked. Since the one or more status variables are stored in different safety levels, it is necessary to check all the status variables assigned to the control unit function corresponding to the safety level of the control unit function and higher safety levels. Accordingly, before the control unit function is executed, the corresponding status variables that are assigned to the control unit functions and have the same or higher safety levels are retrieved in order to determine the approval of the control unit function in question. Furthermore, according to an example embodiment of the present invention, corresponding status variables of lower safety levels are ignored, so that diagnostic functions of lower safety levels cannot block any control unit functions of higher safety levels, even if a fault has been detected. In this way, the integrity of the approval of control unit functions can be ensured. Thus, a fault event of a diagnostic function can only influence the approval of control unit functions that are assigned to the same safety level or lower safety levels.

According to an example embodiment of the present invention, it can be provided for a call context to be automatically analyzed for the correct assignment of the diagnostic functions and the control unit functions to the corresponding safety level by evaluating program code and configuration files for the diagnostic functions and the control unit functions, wherein in particular the program code is parsed, and one or more predetermined configuration files are checked to determine the call container in which the diagnostic functions or the control unit functions respectively call specific interfaces for certain safety levels.

Furthermore, according to an example embodiment of the present invention, the status variable memory areas can be taken into account by masking a read access to the status variables assigned to the control unit function in the status variable memory areas.

Furthermore, according to an example embodiment of the present invention, the assignment of the diagnostic functions to the corresponding status variables and the assignment of the status variables to the control unit function can be carried out using an assignment matrix. This allows flexible adjustment of the assignments of diagnostic functions and control unit functions of different safety levels by simple calibration (even during operation of the control unit) without having to recompile the control unit software or the software of the diagnostic functions.

Adjustments of the assignments of the diagnostic functions to control unit functions are thus easily possible by calibration, since the status variables are maintained at all different safety levels. It is not necessary to configure and integrate the entire program again.

### BRIEF DESCRIPTION OF EXAMPLE EMBODIMENTS

Embodiments are explained in more detail below with reference to the figures.

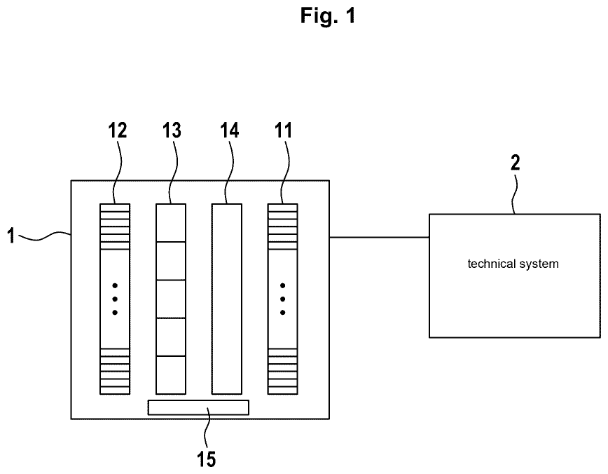

FIG. 1 is a schematic representation of an approval system in a control unit with a plurality of diagnostic functions and a plurality of control unit functions, according to an example embodiment of the present invention.

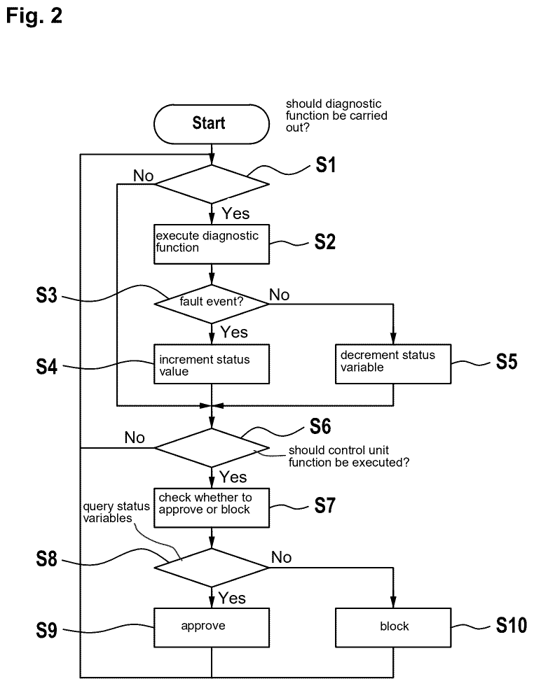

FIG. 2 is a flow chart for illustrating a method for operating a control unit, according to an example embodiment of the present invention.

### DETAILED DESCRIPTION OF EXAMPLE EMBODIMENTS

FIG. 1 is a schematic representation of a control unit 1 for controlling a technical system 2. For example, the control unit can be provided to control a vehicle system or other technical device. A plurality of control unit functions 11 are implemented in the control unit 1 for operating the technical device 2. The control unit functions 11 can include software algorithms and functions for reading sensors and actuating actuators. In particular, control unit functions 11 can include, for example, functions of the operating system, of memory management, central functions of on-board diagnostics, functions of fault memory management and work functions for the implementation of control unit tasks.

Technical systems are often used in safety-critical areas, and therefore the functions used in the control unit 1 must be at least partially protected in a particular way in order to avoid critical conditions that could endanger persons and/or the technical system or other systems. Functions implemented in the control unit 1 are therefore assigned safety levels that ensure certain degrees of protection of the function to be performed. For example, for vehicle functions implemented in a control unit 1 of a motor vehicle, there are classifications according to ASIL (ISO 26262), wherein safety levels QM, ASIL-A, ASIL-B, ASIL-C and ASIL-D are known. The specified safety levels represent, in the order given, increasingly strict protection of the functions in question.

Since control unit functions relating to different functional applications can often be implemented in the control unit 1, such as functions for the steering system, the braking system, the engine control and the like, these functions can be assigned to different safety levels.

In safety-critical systems, it is also required to monitor the control unit functions 11 with the aid of diagnostic functions 12 or to define approval conditions. The diagnostic functions check in an appropriate manner the proper functioning of one or more control unit functions 11. Just like the control unit functions 11, the diagnostic functions 12 are also assigned to respective safety levels with regard to their reliability and protection (integrity).

During operation of the technical system, the diagnostic functions 12 are regularly executed and, if a fault is detected, a corresponding status variable assigned to the diagnostic function by a blocking matrix 15 is adjusted. Often the status variable corresponds to a fault counter that is incremented as soon as a fault event is detected. If certain diagnostic criteria are met and if, after a fault event is detected, the diagnostic function 12 shows proper functioning during a subsequent diagnosis, i.e., no fault is established, the fault counter of the status variable can be decremented if it has not already reached the value zero.

A status variable in a specific status variable memory area is permanently assigned to a corresponding control unit function, represented by a function identifier, by the blocking matrix 15. Due to the classification of the control unit function into safety levels, the diagnostic function describes a status variable memory area of the same safety level by detecting a fault.

It is therefore intended to provide a separate status variable for each safety level, so that—depending on the supported safety levels—a total of one entire status variable memory area 13, which is assigned to a function identifier, results per control unit function. When a fault event is detected by a diagnostic function, the assigned status variable is thus adapted to the relevant status variable memory area, which is assigned to the same safety level as the diagnostic function.

It is provided to automatically analyze the call context in order to correctly assign the diagnostic functions and the control unit functions to the corresponding safety level. For this purpose, the ASIL integrity with which the diagnostic result is reported or the approval is queried by the control unit functions is evaluated by checking program code and configuration files. This analysis is based on two contributions: i) parsing the C code and ii) processing specified configuration files, in particular the AUTOSAR configuration files. For i), the C code is searched for function calls, and the parameters forwarded in them are checked to determine the software component in which the call is made. An analysis is then carried out to determine the time frame or call container in which the function is called (“partition”). This leads to the safety level of the call container. For ii), the configuration files are analyzed. The call container in which the diagnostic function or the control unit function calls specific interfaces is described therein. The safety level is thus also specified.

The control unit functions 11 are coupled to an approval function 14, so that the control unit function 11 may only be executed if an approval has been given. The approval function 14 is based on the blocking matrix 15, which assigns one or more status variables, possibly from different safety levels, to the relevant control unit function 11. The approval function 14 only accesses the status variables of the safety levels that correspond to the safety level of the control unit function 11 to be approved and the higher safety levels. This makes it possible to prevent a diagnostic function of a lower safety level from blocking the approval of a control unit function 11 of a higher safety level. The approval function 14 checks all status variables with regard to approval criteria according to the blocking matrix 15, wherein the corresponding status variable(s) are taken into account in the safety level of the control unit function 11 and in higher safety levels. If one of the status variables does not meet the approval criterion, the execution of the control unit function 11 is blocked.

FIG. 2 illustrates the method sequence described above using a flow chart.

In step S1, it is checked whether a diagnostic function 12 should be carried out. The diagnostic function is designed to check a partial aspect of the functionality of the control unit. If the diagnostic function is to be executed (alternative: yes), the method continues with step S2, otherwise (alternative: no) the method continues with step S6.

In step S2, the diagnostic function is executed. The result of the diagnostic function is the detection of a fault event or the detection of the functionality of the diagnosed function.

In step S3, it is checked whether a fault event is present. If a fault event is present (alternative: yes), in step S4 an associated status variable is incremented and stored in a status variable memory area, associated with the status variable, of the safety level of the diagnostic function.

If, however, the functionality of the function to be diagnosed is established (alternative: no), in step S5 the corresponding status variable in the relevant status variable memory area is decremented, provided that the value of the status variable is not zero. If necessary, further diagnostic criteria can be applied which must be met to allow the status variable to be decremented.

In step S6, it is checked whether a control unit function should be executed. If so (alternative: yes), the method continues with step S7, otherwise it returns to step S1.

The control unit function 11 to be executed is assigned to a specific safety level. Before the control unit function is executed, an approval function, which indicates whether the execution of the control unit function is permitted or blocked, is executed in step S7. The approval function checks the approval or blocking of the control unit function using assigned status variables in the status variable memory areas 13, wherein the assignment is specified according to the blocking matrix.

For this purpose, in step S8, the status variables in the status variable memory area 13 of the safety level assigned to the control unit 1 and all higher safety levels are queried, and the relevant status variable is checked for compliance with the approval criteria. If the approval criteria for the status variable are met in all considered status variable memory areas (alternative: yes), the execution of the control unit function is approved in step S9, and the control unit function is executed. Otherwise (alternative: no), the execution of the control unit function is blocked in step S10.

The status variables can be retrieved from the status variable memory areas 13 using masking. The masking does not allow read access to the status variable memory areas with a safety level lower than the safety level of the control unit function 11 to be executed.

Since the status variable, when run as a counter, must have the value 0 for all considered status variable memory areas, the status variables thus considered in the various status variable memory areas can be summed. The approval criterion then stipulates that the sum of the status variables considered must be 0 in order to allow the relevant control unit function to be approved.

1-10. (canceled)

11. A computer-implemented method for operating an approval manager for approving control unit functions of different safety levels in a control unit of a technical system, the method comprising the following steps:
carrying out diagnostic functions in the control unit, wherein a safety level is assigned to each of the diagnostic functions;
depending on a detection of a fault event or a functionality by a diagnostic function of the diagnostic functions, adjusting an associated status variable in a status variable memory area assigned to the safety level of the diagnostic function; and
carrying out a control unit function, which is assigned to a particular safety level of the different safety levels, depending on one or more associated status variables, wherein only status variables which are stored in status variable memory areas assigned to the safety level of the control unit function or higher safety levels are taken into account.

12. The method according to claim 11, wherein a call context is automatically analyzed for a correct assignment of the diagnostic functions and the control unit functions to the corresponding safety level by evaluating program code and configuration files for the diagnostic functions and the control unit functions, wherein the program code is parsed, and one or more predetermined configuration files are checked to determine a call container in which the diagnostic functions or the control unit functions respectively call specific interfaces for certain safety levels.

13. The method according to claim 11, wherein the assignment of the diagnostic function to the status variable and of one or more status variables to the control unit functions is carried out with using a blocking matrix.

14. The method according to claim 13, wherein the blocking matrix can be adjusted by calibration, during operation of the control unit.

15. The method according to claim 11, wherein the status variable memory areas are taken into account by masking a read access to the specific status variable in the status variable memory areas.

16. The method according to claim 11, wherein the approval manager is executed in the control unit.

17. The method according to claim 11, wherein the safety levels are safety levels specified according to Automotive State Integrity Level (ASIL).

18. An apparatus configured to operate an approval manager for approving control unit functions of different safety levels in a control unit of a technical system, the apparatus configured to:
carry out diagnostic functions in the control unit, wherein a safety level is assigned to each of the diagnostic functions;
depending on a detection of a fault event or a functionality by a diagnostic function of the diagnostic functions, adjust an associated status variable in a status variable memory area assigned to the safety level of the diagnostic function; and
carry out a control unit function, which is assigned to a particular safety level of the different safety levels, depending on one or more associated status variables, wherein only status variables which are stored in status variable memory areas assigned to the safety level of the control unit function or higher safety levels are taken into account.

19. A non-transitory machine-readable storage medium on which are stored commands operating an approval manager for approving control unit functions of different safety levels in a control unit of a technical system, the commands, when executed by at least one data processing device, causing the at least one data processing device to perform the following steps:
carrying out diagnostic functions in the control unit, wherein a safety level is assigned to each of the diagnostic functions;
depending on a detection of a fault event or a functionality by a diagnostic function of the diagnostic functions, adjusting an associated status variable in a status variable memory area assigned to the safety level of the diagnostic function; and
carrying out a control unit function, which is assigned to a particular safety level of the different safety levels, depending on one or more associated status variables, wherein only status variables which are stored in status variable memory areas assigned to the safety level of the control unit function or higher safety levels are taken into account.
